(19) United States
(12) Patent Application Publication
(10) Pub. No.: US 2006/0146772 A1
(43) Pub. Date: Jul. 6, 2006

(54) Digital media interface/player device

(76) Inventors: Ziv Geva, Rehovot (IL); Ofer Leizerovich, Nes-Ziona (IL); Roy Alexander Doron, Tel-Aviv (IL)

Correspondence Address: Angenehm Law Firm, Ltd., P.O. Box 48755, Coon Rapids, MN, 55448-0755, US

(21) Appl. No.: 11/189,838

(22) Filed: Jul. 27, 2005

Related U.S. Application Data
(63) Continuation-in-part of application No. 11/028,044, filed on Jan. 4, 2005.

(51) Int. Cl. H04Q 7/24

(52) U.S. Cl. 370/338

(57) ABSTRACT

The present invention is an easy to use digital personal multimedia interface device or media player device. The device allows users to purchase memory units containing media files and then obtain activation keys which make a given number of these files available for playing. Alternatively, the device allows users to activate files from a remote source using activation keys. The first embodiment is designed to be fully operated by young children, and allows access to a large number of media files; the child can play a particular media file using the activation key. The second embodiment is designed for the use of adults. The key enables the user to play media files from the list of available files for a given amount of time. For its operation the activation key may connect the device physically, communicate with it via wireless means or connect to the device's remote control.

This application is a Continuation-in-Part of U.S. patent application Ser. No. 11/028044, filed Jan. 4, 2005, to which application priority is claimed. The entire disclosure of which is incorporated herein by reference.

### FIELD OF THE INVENTION

The present invention relates in general to digital media players and multimedia interface devices. More particularly, the present invention relates to digital media players with prerecorded memory and to multimedia interface devices which can be independently operated by young children.

### BACKGROUND

A great number of digitally operated devices which combine audio and video players may be found on the market today. These media players can be divided into two fundamental types. The first type of players includes devices which play prerecorded content stored on media storage medium types which are commonly not part of the device itself and which are separately sold, such as CD and DVD players. The second type of devices commonly include a built-in storage medium and enable users to load content into the device and to change the content stored on the inner memory, such as personal media players (PMP).

U.S. patent application no. 2004175098, for instance, discloses a personal media player which uses a digital media processing system. The system comprises a video rendering subsystem, a music rendering subsystem, and a picture rendering subsystem-to produce video, audio and still-pictures which are ported to the PMP from another source.

Current market trends show that the popularity of PMP devices is growing rapidly, but this technology has two major drawbacks. First, most often users load their players with audio and video files which were downloaded from the internet whereas a large portion of these files were obtained illegally through file sharing applications or are of poor quality and low integrity. The second drawback is that in order to make use of these devices, users are required to prepossess some technical knowledge so as to be able to transfer the desired content from a source device, commonly a host computer or server, onto a personal computer associated with the media player, and then, from the personal computer onto the personal media player. Such skills are still beyond the technical know-how of many potential users.

There is therefore a need for a digital multimedia player which would have the advantages of the personal media players but would allow content providers to offer users quality content. There is a further need for a digital multimedia player which would enable users to utilize personal media players as a stand-alone unit without having to completely rely on having access to PC based file sharing applications and know-how of operating thereof.

### SUMMARY

Some embodiments of the present invention relate to a multimedia interface device or media player device which is suited to be operated by young children. In accordance with some embodiments of the present invention, the device may include a data source module, such as a local memory storage module or a communication module to a remote data source, and a content activation module. The storage module and the communication module may be adapted to provide a plurality of content files (for example, media files, such as image files, audio files, video files, etc.). The content activation module may be associated with one or more media files available through the data source module. In accordance with some embodiments of the present invention, the content activation module may be adapted to allow access to one or more media files available through the data source module upon receiving a compatible activation key.

In accordance with some embodiments of the present invention, the storage module may include one or more of an internal disk, a changeable CD, or a flash memory unit. Alternatively, the memory means may be an external memory unit such as a CD, a DVD, a DVR, or a flash memory device. The communication module may allow transference of data between the device and a remote data source such as an internet server or a cable or satellite content provider.

As part of some embodiments of the present invention, the content activation module may be associated with an activation key. As part of some embodiments of the present invention, the activation key may include one or more of a key unit, an activation code. As part of some embodiments of the present invention, the content activation module may be adapted to communicate with the activation key over a wireless communication link established therewith. In accordance with further embodiments of the present invention, the content activation module may be adapted to communicate with the identification key when the activation key is placed in physical contact with the player or with some auxiliary component associated with the player. In accordance with some embodiments of the present invention, the content activation module may be adapted to communicate with the activation key when the activation key is placed in physical contact with a specific portion of the player or with a specific auxiliary component associated with the player, for example, when the activation module is placed in physical contact with a communication port associated with the player.

In accordance with some embodiments of the present invention, the content activation module may include or may be associated with a wireless communication module. The wireless communication module may be adapted to establish a wireless communication link with the activation key. For example, in accordance with some embodiments of the present invention, the wireless communication module may be adapted to establish an RF communication link with the activation key. In accordance with some embodiments of the present invention the wireless communication module may include an RF transceiver, for example, and RFID transceiver. In accordance with further embodiments of the present invention, the wireless communication module may be adapted to establish a communication link with an activation key, when the activation key is brought in substantially close physical proximity to the wireless communication module. For example, in accordance with some embodiments of the present invention the wireless communication module may be adapted to establish a Bluetooth communication link with the activation key, when the activation key is brought in substantially close proximity to the wireless communication module.

In accordance with some embodiments of the present invention, the content activation module may include or may be associated with one or more physical interfaces. The interfaces may be configured to receive one or more compatible activation keys. In accordance with some embodiments of the present invention, the physical interfaces may be adapted to establish a communication link with a compatible activation key when the compatible activation key is brought in physical contact with the appropriate physical interface.

In accordance with some embodiments of the present invention, the content activation module may be adapted to identify the activation key upon establishing a communication link with an activation key. In accordance with some embodiments of the present invention, the content activation module may be configured to authenticate the compatibility of the activation key upon establishing a communication link with the activation key and the identification thereof. In accordance with further embodiments of the present invention, once the content activation module has identified the activation key, and the activation key was found to be compatible, the content activation module may be adapted to require an additional authentication input from another source in order to enable access to the content files associated with the activation key. For example, in accordance with some embodiments of the present invention, once the content activation module has identified the activation key, and the activation key was found to be compatible, the content activation module may be adapted to require the user to input a specific input sequence (a pin code, a secret code, etc.) in order to enable access to the content files associated with the activation key.

In accordance with some embodiments of the present invention, once the activation key has been identified or once the activation key has been identified and authenticated, the content activation module may enable access to one or more content files associated with the activation key. In accordance with some embodiments of the present invention, the files or the extent of the files which the user may be allowed to access may be associated with the activation key which was used to gain access to the content files. In accordance with further embodiments of the present invention, once the activation key has been identified or once the activation key has been identified and authenticated the content activation module may be adapted to enable access to one or more content files associated with the activation key to a predetermined time period. In accordance with some embodiments of the present invention, the amount of time during which the user is allowed to access the content files may be associated with the activation key which was used to gain access to the content files. In accordance with yet further embodiments of the present invention, once the activation key has been identified or once the activation key has been identified and authenticated the content activation module may be adapted to enable to access one or more of the content files associated with the activation key a predetermined number of times. In accordance with some embodiments of the present invention, the number of times that a user may be allowed to access the content files may be associated with the activation key used to gain access.

The device and the activation key may be designed to be easily grasped and operated by small children. The files may be loaded onto the device from an external source such as from a web server using a personal computer. The device may be portable and may be operated using a remote control. The activation key which activates the device may be, for example, a mobile phone or a mobile phone's SIM Card.

### BRIEF DESCRIPTION OF THE DRAWINGS

The above, as well as other advantages of the present invention will become readily apparent to those skilled in the art from the following detailed description of a preferred embodiment when considered in the light of the accompanying drawings in which:

FIGS. 1A and 1B are illustrations of the device according the first embodiment of the present invention;

FIG. 2 is an illustration of the activation keys according to the first embodiment of the present invention.

FIGS. 3A, 3B and 3c are a block diagrams illustrations of a media player device in accordance with some embodiments of the present invention.

### DETAILED DESCRIPTION OF THE PREFERRED EMBODIMENTS

The present invention offers a new and innovative system and method which enables young children to independently operate media devices, providing them with full control over the devices' operation. The media devices may include interface devices such as Video On Demand (VOD) devices, internet protocol television (IPTV) device, game consoles, cable and satellite TV set top-boxes and television set controller, or media players such as MP3 players, iPods, multimedia players and the like. Childproof and especially safe, the invention allows the child to easily and independently choose the media content and control its operation. The child can then choose to play his or her favorite song, select a television program or a movie.

Some embodiments of the present invention relate to an easy to use digital personal multimedia player which has all the advantages of commonplace players but does not rely on importing files from an external source for its operation. Some embodiments of the present invention enable users to purchase, for example, memory units containing a large number of media files and then obtain temporary activation keys which make a given number of these files available for playing. Other embodiments of the present invention relate to an easy to use multimedia interface device. Such an interface enables the selection of a content file for transmission or downloading from a remote location. In these embodiments the device uses such services which are know in the art as VOD or using any variations of such services including but not limited to: Near Video on Demand (NVOD), Virtual Video on Demand (VVOD) and IPTV. The device is especially suited to be used by users who are not technologically advanced, such as young children, and would otherwise depend on the help of others to operate the device.

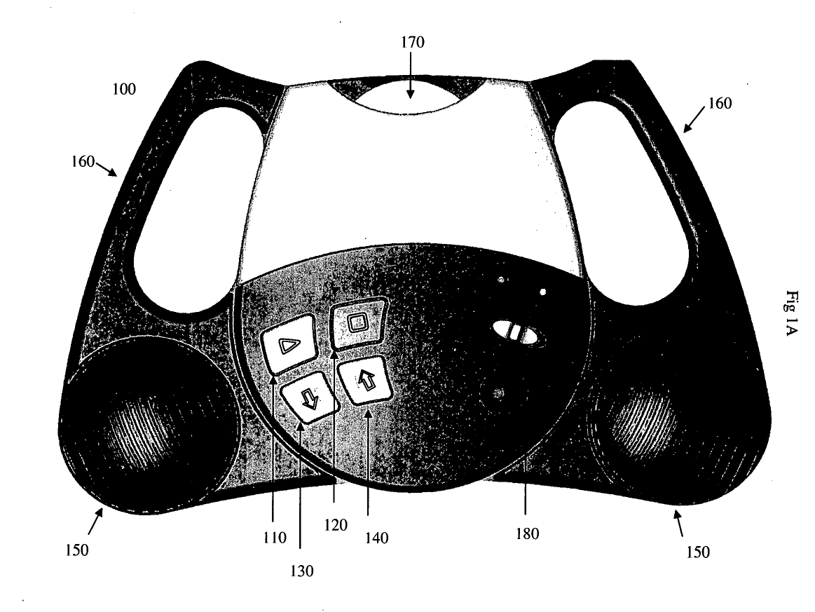

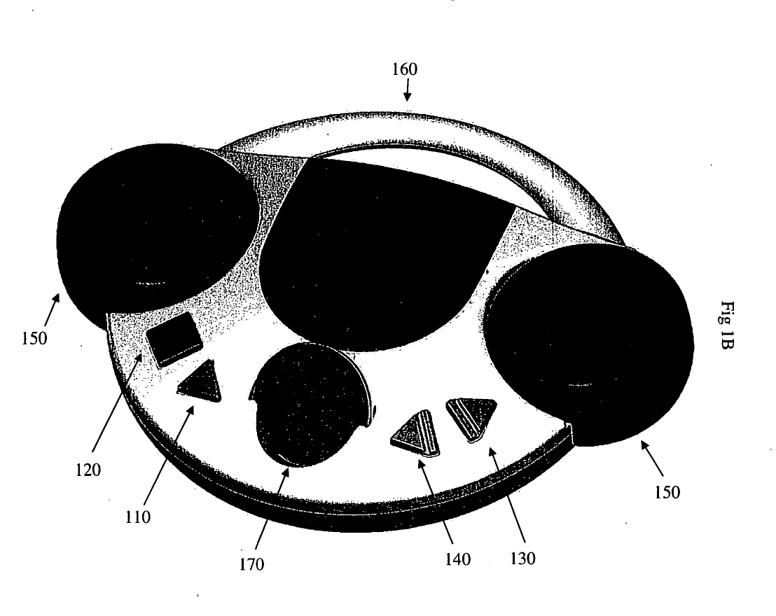

The first embodiment of the invention, which is illustrated in FIG. 1A, is designed to be fully operated by young children. The device 100 contains an internal memory which holds a large number of media files and operating buttons 110-140. The operation buttons, which are especially designed to be used by small children, may contain Play 110, Stop 120 buttons. The internal memory may be an internal disk, a changeable CD or a flash memory unit. The device also includes built-in loudspeakers 150, an image and video display screen 190, and in order to be suited for children it may also have easy to grasp handles 160.

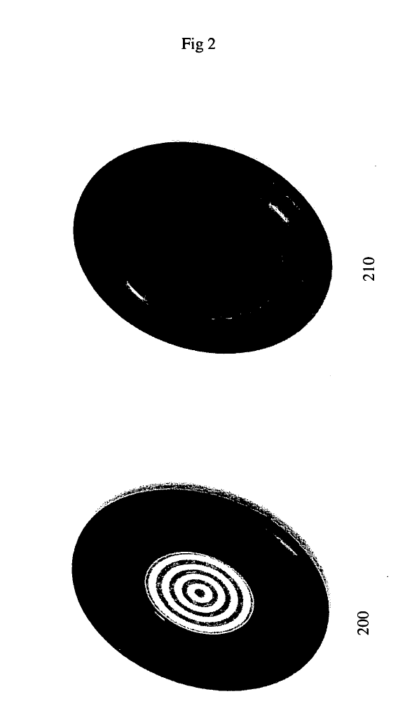

The internal memory may be loaded with a bulk of media files suited for children, such as children's songs or video clips, and then the device can be fully operated by the child. The child plays a single media file by placing a key, illustrated in FIG. 2, inside or on the device. Each key 200, 210 is programmed to play a particular media file from the list of files which are loaded into the device. Once the child places the key in its appropriate place the file automatically starts playing. The child can then choose his or her desired file by choosing the right key, and then playing it without needing the help of an adult. When the key is in place the media file can be replayed and stopped by using the devices Play 110 and Stop 120 buttons. In the particular example which is illustrated in FIG. 1 and 2 the keys 200, 210 need to be placed in notch 170 of device 100 in order to operate it. The device may also include a power button 180 allowing an adult to turn it on and off. The second embodiment of the invention operates on similar principles but is designed for the use of adults. Similarly to the first embodiment it also includes an internal loadable memory and an activation key, but in this embodiment the key enables the user to play media files from the loaded list of files for a given amount of time. Users may, for instance, load a bulk of songs or video clips or any other desirable content of a particular kind of music, such as jazz or country music, and then separately purchase activation keys for given amounts of playing hours.

Loading the media files into the device may be done by replacing the internal memory media, such as a disc or a flash memory unit, or by loading data or content onto the internal memory by connecting to a computer. Some embodiments of the player may enables users to simply purchase the bulks of media files, which may contain up to hundreds or even thousands of items, depending on the internal memory size, and then play them using the activation keys and thus may not require the users to undergo the process downloading individual files from the internet or convert files from CDs and DVDs in order to create their playlist.

The third embodiment of the present invention the activation key is designed to interact with a multimedia interface device, wherein said interface enables the selection of a content file for transmission or downloading from a remote location. According to some embodiments of the present invention, the multimedia interface device is a remote control associated with a multimedia display device, such as a television or a satellite and cable TV set top-box. The remote control device enables the selection of the downloading or transmission of movies from a remote movie repository, using such services as, but not limited to, VOD, NVOD, VVOD, IPTV and interactive program services; It may also operate a game console such as Xbox and PlayStation. According to this embodiment, the present invention provides children with the ability to select movies from such services by using a designated activation key, as described in greater detail in previous embodiments of the present invention and to activate a remote control, wherein such a process would not require the intervention of an adult. In other embodiments of the present invention, the activation of the remote control enables the child to select a television channel or broadcasting program, and control the operation of the television set—turning it on and off and controlling its volume.

Additionally, in some embodiments of the present invention, the multimedia interface device is any computer interface such as keyboard, mouse, or game console, which enables the selection of a content file for transmission or downloading through a communication network, such as the Internet, from a remote content server.

For all of the embodiments detailed above the connection between the device and the activation key may be via wired or wireless technology such as Bluetooth. It may also operate using radio frequency (RF) transmissions; in this case the key may be an RF identification (RFID) tag. Operating the device which uses wireless or RF transmissions to communicate with the key allows users to bring the key to the device's proximity in order to activate it, and do not have to rely on the user physically connecting the key to the device.

The wireless communication between the device and the key may operate in accordance with master-slave configuration. The device, as the master, may initiate the communication by periodically searching for the presence of an activation key in its range of transmission. The key may therefore be a logical key housed inside any type of a portable device which includes wireless communication means, such as a cellular phone or a PDA device. In such cases the key is loaded onto the SIM card of the cellular phone or to the internal memory of the PDA and the interface device or the multimedia device can identify the activation key by communicating with the portable device whenever the portable device is in its transmission range.

According to a further option of the present invention, the interface device or the multimedia device are controlled by a remote control, wherein said remote control is activated by an activation key in a similar manner as described above.

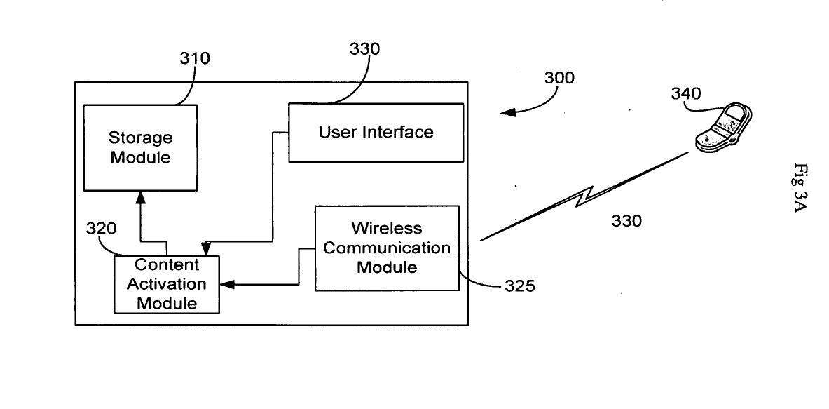

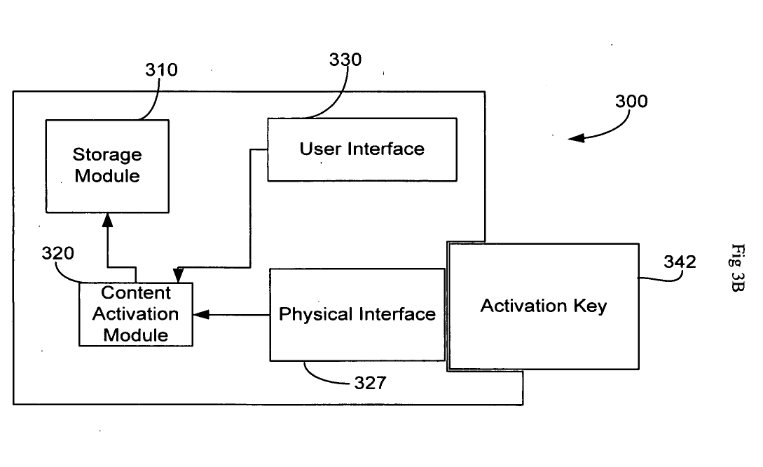

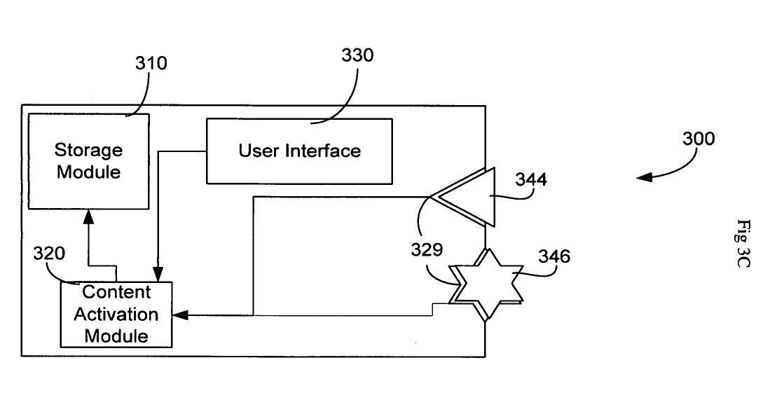

Reference is now made to FIG. 3A which is a block diagram illustration of a media player device in accordance with some embodiments of the present invention. In accordance with some embodiments of the present invention, the multimedia interface device or media player device 300 may include a data source module 310, and a content activation module 320. According to some of the proposed embodiments the data source module 310 may be a local memory storage which is adapted to store a plurality of content files (for example, media files, such as image files, audio files, video files, etc.).

The content may be pre-stored in the multimedia interface device or media player device 300. According to other embodiments of the present invention the data source module 310 may be a communication module which communicates between the multimedia interface device or media player device 300 and a remote data facility, such as an internet server or a cable or satellite content provider. The content activation module 320 may be associated with one or more media files stored in the data source 310. In accordance with some embodiments of the present invention, the content activation module may be adapted to allow access to one or more media files which are accessible through the data source module upon receiving or upon identifying a compatible activation key. The media player may also include a user interface 330 to enable a user to input data into the player and to control the operation of the player.

In accordance with some embodiments of the present invention, when the data source module 310 is a storage module, it may include an internal disk, a changeable CD, a flash memory unit or a combination thereof. In accordance with further embodiments of the present invention, the storage module may include one or more external memory units such as a CD, a DVD, a DVR, a flash memory device.

As part of some embodiments of the present invention, the content activation module 320 may be associated with an activation key 340. As part of some embodiments of the present invention, the activation key 340 may include more then one key units, or activation codes.

In accordance with some embodiments of the present invention, the activation key 340 may include identification data to identify the activation key 340. In accordance with further embodiments of the present invention, the activation key 340 may include additional data. For example, the activation data may include data relating to the content files with which a particular key is associated. In accordance with some embodiments of the present invention, the content activation module 320 may be adapted to grant access to specific pre-stored files in accordance with data stored in a certain activation key which relates to such pre-stored content. In accordance with further embodiments of the present invention, the activation key may include additional data, either in addition or in alternative to data relating to specific pre-stored content, rather in accordance with some embodiments of the present invention, such data may include for example, but is not limited to a time period value which is indicative of the amount of access time that a certain key may provide when using a certain activation key to activate content which is pre-stored in the multimedia interface device or media player device 300, a number relating to the amount of content files which may be accessed when using a certain activation key, and the like.

In accordance with some embodiments of the present invention, the player may include a wireless communication module 325. In accordance with some embodiments of the present invention, the wireless communication module may be adapted to establish a wireless communication link with the wireless communication device 340, associated with the multimedia interface device or media player device 300. For example, in accordance with some embodiments of the present invention, the wireless communication module 325 may be adapted to establish an RF communication link with the activation key 340. In accordance with some embodiments of the present invention the wireless communication module 325 may include an RF transceiver, for example, an RFID transceiver. In accordance with further embodiments of the present invention, the wireless communication module may be adapted to establish a communication link with an activation key, when the activation key is brought in substantially close physical proximity to the wireless communication module. For example, in accordance with some embodiments of the present invention the wireless communication module may be adapted to establish a Bluetooth communication link with the activation key, when the activation key is brought in substantially close proximity to the wireless communication module. As part of some embodiments of the present invention, the content activation module 320 may be adapted to communicate with the activation key 340 over the wireless communication link established therewith.

In accordance with some embodiments of the present invention, the content activation module 320 may be adapted to identify the activation key 340 upon establishing a communication link with an activation key 340. In accordance with some embodiments of the present invention, the content activation module 320 may be configured to authenticate the compatibility of the activation key 340 upon establishing a communication link with the activation key 340 and the identification thereof. In accordance with further embodiments of the present invention, once the content activation module 320 have identified the activation key 340, and the activation key 340 was found to be compatible, the content activation module 320 may be adapted to require an additional authentication input from another source in order to enable access to the content files associated with the activation key 340. For example, in accordance with some embodiments of the present invention, once the content activation module 320 has identified the activation key 340, and the activation key 340 was found to be compatible, the content activation module 340 may be adapted to require the user to input a specific input sequence (a pin code, a secret code, etc.) in order to enable access to the content files associated with the activation key 340.

In accordance with some embodiments of the present invention, once the activation key 340 has been identified or once the activation key 340 has been identified and authenticated, the content activation module 320 may enable access to one or more content files which are available through the data source module 310, associated with the activation key 340. In accordance with some embodiments of the present invention, the files or the extent of the files which the user may be allowed to access may be associated with the activation key 340 which was used to gain access to the content files. In accordance with further embodiments of the present invention, once the activation key 340 has been identified or once the activation key 340 has been identified and authenticated the content activation module 320 may be adapted to enable access to one or more content files associated with the activation key to a predetermined period of time.

In accordance with some embodiments of the present invention, the amount of time during which the user is allowed to access the content files may be associated with the activation key 340 which was used to gain access to the content files. In accordance with yet further embodiments of the present invention, once the activation key 340 has been identified or once the activation key 340 has been identified and authenticated, the content activation module 320 may be adapted to enable to access one or more of the content files associated with the activation key 340 a predetermined number of times. In accordance with some embodiments of the present invention, the number of times that a user may be allowed to access the content files may be associated with the activation key 340 used to gain access.

Reference is now made to FIG. 3B, which is a block diagram illustration of a media player device in accordance with some embodiments of the present invention. In the embodiment shown in FIG. 3B the player includes a physical interface 327, rather then the wireless communication module 325 shown in FIG. 3A. In accordance with some embodiments of the present invention, the physical interface may 327 be adapted to receive one or more activation key 342. In accordance with some embodiments of the present invention, the physical interface 327 may be adapted to establish a communication link or some other suitable connection with the activation key 342 when the activation key 342 is brought to a substantially physical contact with the physical interface 327. In accordance with some embodiments of the present invention, similarly to the embodiments described in FIG. 3A, once the activation key 340 has been identified or once the activation key 342 has been identified and authenticated, the content activation module 320 may enable access to one or more content files which are available through the data source module 310 and are associated with the activation key 342.

Reference is now made to FIG. 3C, which is a block diagram illustration of a media player device in accordance with some embodiments of the present invention. In the embodiment shown in FIG. 3C the player includes a plurality of unique physical interfaces 329. Here, the physical 329 interfaces are shown to differ from one another in the shape of the interface or in the shape of the input slot of the interface. Thus, in accordance with the embodiments shown, each physical interface 329 is adapted to receive a specific activation key or keys 344 and 346 having a unique feature or characteristic, such as a unique shape, for example, or at least a portion shaped such that the activation key may be engaged with a designated interface 329. In the embodiment shown in FIG. 3C the physical interfaces are shown to have different shapes, and are therefore adapted to be engaged with different activation keys which differ from one another in their physical shape. However, it should be noted that the present invention is not limited in this respect, and additional features may be used to differentiate the different activation keys or different kinds of activation keys. Such differences may include but are not limited to a designated pin code, a specific marking, a specific color.

In accordance with some embodiments of the present invention, the physical interface 329 and the activation key 344 and 346 may be designed such that only a compatible key may be engaged with the suitable interface. In accordance with further embodiments of the present invention, the differentiating feature or characteristic may be used to identify the activation key. It should be noted, that in this embodiment the communication of identification data between the activation key and the content activation module may not be necessary since the activation key may be engaged with a certain interface if, and only if, the activation key is characterized by a certain feature or characteristic.

In accordance with some embodiments of the present invention, each activation key or each group of activation keys which are characterized by a specific feature or characteristic may be associated with one or more content files which are available through the data source module 310. Thus, when using a certain activation key or a certain kind of activation keys, a user may access a specific portion of the content files stored in the player, but not all the files stored thereon. It should be noted, that the activation keys or the different kinds of activation key may be associated with other information relating to the content stored in the multimedia interface device or media player device 300. As discussed in greater detail hereinabove, such information may include data relating to the amount of access time which may be enabled when using a certain key, the number of content files which may be accessed when using a certain key, and the like.

While the above description contains many specifications, these should not be construed as limitations on the scope of the invention, but rather as exemplifications of the preferred embodiments. Those skilled in the art will envision other possible variations that are within its scope. Accordingly, the scope of the invention should be determined not by the embodiment illustrated, but by the appended claims and their legal equivalents.

What is claimed is:

1. A media interface device comprising:
a content activation module adapted to grant access to one or more of the pre-stored content files, wherein said content files are stored at an external source, and wherein a media interface enables the establishment of communication with said external source; and
wherein said content activation module is adapted to grant access to one or more of the pre-stored content files upon receiving an activation signal having an ID associated with one or more of the pre-stored content files, said activation signal being received from an activation key.

2. The media interface device of claim 1, wherein the activation key is associated with a wireless communication device and wherein said content activation module is adapted to receive the activation signal over a wireless communication link established with the wireless communication device.

3. The media interface device of claim 2, further comprising a wireless communication module adapted to establish a wireless communication link with the activation key.

4. The media interface device of claim 3, wherein the wireless communication module is adapted to establish a wireless communication link with the activation key when the activation key is brought into a substantially close distance from said interface.

5. The media interface device of claim 4, wherein the wireless communication module comprises an RFID transceiver.

6. The media interface device of claim 1, wherein the activation key is associated with a physical key, and wherein said content activation module is adapted to receive said activation key over a physical link with the physical key.

7. The media interface device of claim 5, further comprising a physical interface adapted to establish a physical link with the activation key.

8. The media interface device of claim 7, wherein the physical interface is adapted to establish a physical link with the activation key when the activation key is engaged with said physical interface.

9. The device of claim 1 wherein the external source is a communication server.

10. The device of claim I wherein the external source is a remote multimedia repository.

11. The device of claim 10 wherein the remote multimedia repository provides VOD services.

12. The device of claim I wherein the files are activated in random order.

13. The media interface device of claim 1, wherein said content activation module is adapted to grant access to specific pre-stored files in accordance with the specific activation key which was used to gain access to the pre-stored content files.

14. The media interface of claim 1, wherein said content activation module is adapted to grant access to the pre-stored content files for a certain period of time in accordance with the specific activation key which was used to gain access to the pre-stored content files.

15. The media interface of claim 1, wherein said content activation module is adapted to grant access to a specific amount of pre-stored content in accordance with the specific activation key which was used to gain access to the pre-stored content files.

16. The media interface of claim 1, wherein said content activation module is adapted to grant access to specific pre-stored content files in accordance with a unique feature associated with the activation key which was used to gain access to the pre-stored content files.

17. The device of claim 1 wherein said device is a remote control for controlling a multimedia player device.

18. The device of claim 1 wherein said device is a remote control for controlling a satellite and cable TV set top-box.

19. The device of claim 1 wherein said device is a remote control for controlling an internet protocol television (IPTV) service.

20. The device of claim 1 wherein said device is implemented as part of a multimedia player device interface control.

21. The device of claim 1 wherein said device is implemented as part of a communication device for controlling a satellite and cable TV set top-box.

22. A method of granting access to one or more pre-stored content files stored at a remote media content source through a media interface device, comprising:
receiving an activation signal including an ID associated with one or more of the pre-stored content files;
transmitting the activation signal via said interface device to the remote media content source;
granting access to one or more pre-stored content files in accordance with the specific activation key which was used to gain access to the pre-stored content files.

23. The method of claim 22, wherein the activation key is associated with a wireless communication device, and wherein said receiving comprises of receiving the activation key associated with one or more pre-stored content files stored in remote media content source over a wireless communication link established with the wireless communication device.
